(19) United States
(12) Patent Application Publication
(10) Pub. No.: US 2015/0361309 A1
(43) Pub. Date: Dec. 17, 2015

(54) LIQUID CELLULOSE ESTER ADHESIVES

(71) Applicant: Celanese Acetate LLC, Irving, TX (US)

(72) Inventors: Michael Combs, Pembroke, VA (US); Lizbeth Milward, Blacksburg, VA (US)

(73) Assignee: Celanese Acetate LLC, Irving, TX (US)

(21) Appl. No.: 14/737,837

(22) Filed: Jun. 12, 2015

Related U.S. Application Data
(60) Provisional application No. 62/011,133, filed on Jun. 12, 2014.

(51) Int. Cl. C09J 101/08; B32B 7/12; B32B 37/12; C09J 103/06; C09J 5/00

(52) U.S. Cl. CPC C09J 101/08; C09J 103/06; C09J 5/00; B32B 37/1284; B32B 7/12; C09J 2401/00; C09J 2403/00; C09J 2401/006; B32B 2250/02; B32B 2255/26

(57) ABSTRACT

Liquid adhesives may be produced that include plasticized cellulose esters, plasticized starch ester, or both. For example, an adhesive may include a cellulose ester, a starch ester, or both at about 1% to about 30% by weight of the adhesive; and a plasticizer, wherein the adhesive has a dynamic viscosity of about 100 Pa·s or less at 25° C. and a shear rate of 40 s⁻¹. In some instances, the plasticizer may be at about 20% to about 97% by weight of the adhesive, about 40% to about 97% by weight of the adhesive, or about 80% to about 97% by weight of the adhesive. In some instances, the adhesive may consist essentially of (1) the plasticizer and (2) the cellulose ester, the starch ester, or both.

### BACKGROUND

The exemplary embodiments described herein relate to liquid adhesives.

Adhesives are used in many high-speed, product manufacturing processes. The most common adhesives used for such processes are emulsion adhesives, hot melt adhesives, and solvent based adhesives. Emulsion adhesives and solvent based adhesives include significant amounts of solvent or diluent, which provides a low viscosity and allows for a uniform, thin adhesive application onto a surface. However, the solvent needs to be removed for the adhesive to work. Generally, emulsion adhesives and solvent based adhesives are applied at room temperature and heat treated to cure the adhesive and remove solvent. Depending on the processing conditions, the length of a drying oven can be significant. For example, a drying oven for a conventional emulsion adhesive application line may extend from 50 to 100 feet and take up about 500 to 1000 feet of floor space, which at about $0.50/ft²/month costs about $3000 to $6000 per year. In addition to the cost of that length of oven, the energy consumption to remove that much solvent is high.

On the other hand, hot melt adhesives may be extruded at high speeds and cured in a relatively short time. However, in addition to expensive extrusion equipment, the energy required to heat the adhesive to provide a consistent application of adhesive to the surface makes hot melt adhesives for high-speed processes less desirable.

Further, both emulsion adhesives and hot melt adhesives are generally synthetic, petroleum-based products. Such adhesives often interfere with recycling processes like repulping of paper products and removal of labels from bottles. Therefore, adhesives that perform in high-speed processes with reduced post-processing requirements and compatibility with recycling would be of value.

### BRIEF DESCRIPTION OF THE DRAWINGS

The following figures are included to illustrate certain aspects of the embodiments presented herein, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-C provide illustrations of nonlimiting examples of article configurations according to at least some embodiments described herein.

FIGS. 2A-D provide illustrations of nonlimiting examples of article configurations according to at least some embodiments described herein.

### DETAILED DESCRIPTION

The exemplary embodiments described herein relate to liquid adhesives, specifically those including plasticized cellulose esters, plasticized starch ester, or both. As used herein, the term “liquid adhesive” refers to an adhesive composition that (1) has a dynamic viscosity of about 100 Pa·s or less at 25° C. and a shear rate of 40 s⁻¹, (2) exhibits shear thinning above 1000 s⁻¹, or (3) a combination of (1) and (2). As used herein, the term “plasticizer” refers to a compound that decreases the glass transition temperature (“T_{g}”) of the polymer being plasticized.

In some embodiments, the liquid adhesives described herein may be useful for high-speed coating/adhering methods. Generally, the plasticizers in the liquid adhesives described herein interact with the cellulose esters or starch esters to impart adhesive properties thereto. The plasticizers may, in some instances, also act as solvents or diluents. Therefore, in some instances, a brief heating may be performed to drive off plasticizer. In some instances, the plasticizers may include volatile to semi-volatile plasticizers such that the time and distance associated with heating is significantly less as compared to emulsion adhesives and solvent based adhesives. Reducing the time and distance associated with heating would advantageously reduce energy costs and machinery footprint as compared to those associated with emulsion adhesives and solvent based adhesives.

In some instances, two or more plasticizers may be used in liquid adhesives composition. In some instances, it has been observed that two or more plasticizers may have synergistic effects where for the same total weight percent of total plasticizer, multiple plasticizers may have a lower viscosity of the liquid adhesive than either of the individual plasticizers alone, which is an unexpected observation.

Additionally, because liquid adhesives described herein include cellulose esters, starch esters, or both, the adhesives are more compatible with recycling processes (e.g., repulping and caustic baths to remove labels from bottles).

Further, the properties of the liquid adhesives (e.g., optical clarity, adhesion strength, and degradability) may be tailored by changing ratios and compositions of the components thereof.

As used herein, the term “bio-derived” refers to a compound or portion thereof originating from a biological source or produced via a biological reaction. The bio-derived portion of a liquid adhesive described herein refers to the mass percent that is bio-derived.

As used herein, the term “food-grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”).

As used herein, the term “semi-volatile” refers to compounds having a boiling point of about 260° C. to about 400° C.

As used herein, the term “volatile” refers to compounds having a boiling point of about 50° C. to about 260° C.

As used herein, the term “molecular weight” refers to a polystyrene equivalent number average molecular weight (“Mₐ”).

As used herein, the term “water-free” refers to a composition having no more water than is naturally present at standard temperature and pressure with about 100% relative humidity. As used herein, the term “substantially water-free” refers to a composition having no more than about 1% by weight of water above the concentration of water that is naturally present at standard temperature and pressure with 100% relative humidity.

It should be noted that when “about” is used in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

In some embodiments, the liquid adhesives described herein may comprise plasticized cellulose esters, plasticized starch esters, or both, wherein the plasticizers are present in an amount of about 0% to about 97% by weight of the liquid adhesive. In some embodiments, the plasticizers may be present in liquid adhesives described herein in an amount ranging from a lower limit of about 0%, 10%, 20%, 50%, 75%, 85%, or 90% by weight of the liquid adhesive to an upper limit of about 97%, 95%, 90%, 75%, or 50% by weight of the liquid adhesive, wherein the amount may range from any lower limit to any upper limit and encompass any subset therebetween (e.g., about 40% to about 80%).

In some embodiments, cellulose esters may be present in liquid adhesives described herein in an amount ranging from a lower limit of about 1%, 3%, 5%, or 10% by weight of the liquid adhesive to an upper limit of about 30%, 20%, 15%, or 10% by weight of the liquid adhesive, wherein the amount may range from any lower limit to any upper limit and encompass any subset therebetween.

In some embodiments, the liquid adhesives described herein may consist essentially of cellulose ester and plasticizers. In some embodiments, the liquid adhesives described herein may consist of cellulose ester and plasticizers.

Cellulose esters suitable for use in conjunction with liquid adhesives described herein may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

Cellulose esters suitable for use in conjunction with liquid adhesives described herein may, in some embodiments, have a degree of substitution of the ester substituent ranging from a lower limit of about 0.5, 1.2, or 2 to an upper limit of less than about 3, about 2.9, 2.7, or 2.5, and wherein the degree of substitution may range from any lower limit to any upper limit and encompass any subset therebetween.

In some embodiments, cellulose esters described herein may have a molecular weight ranging from a lower limit of about 10,000, 15,000, 25,000, 50,000, or 85,000 to an upper limit of about 300,000, 200,000, 150,000, 125,000, 100,000, or 85,000, and wherein the molecular weight may range from any lower limit to any upper limit and encompass any subset therebetween.

In some embodiments, cellulose esters described herein may have an intrinsic viscosity ranging from a lower limit of about 0.5 dL/g, 0.7 dL/g, or 1.0 dL/g to an upper limit of about 2.0 dL/g, 1.7 dL/g, 1.5 dL/g, or 1.3 dL/g, and wherein the intrinsic viscosity may range from any lower limit to any upper limit and encompass any subset therebetween. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$I V = ( \frac{k}{c} ) ( antilog ( ( log {n}_{rel} ) \text{/} k ) - 1 ) \qquad Equation 1$$

where

$${n}_{rel} = ( \frac{{t}_{1}}{{t}_{2}} ) ,$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

Cellulose esters suitable for use in conjunction with liquid adhesives described herein may be derived from any suitable cellulosic source. Suitable cellulosic sources may, in some embodiments, include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), kudzu, and the like, and any combination thereof. Further, it has been surprisingly discovered that the clarity of adhesives described herein does not appear to be substantially impacted by the cellulosic source from which the cellulose esters are derived. This is unexpected because some existing cellulose ester products (that do not have adhesive properties) require high quality, expensive cellulosic sources (e.g., hardwoods with low hemicellulose content) to achieve high clarity.

In some embodiments, the cellulose ester may be recycled from other cellulose ester materials. For example, cellulose acetate tow used in producing, for example, cigarette filters may be used for producing liquid adhesives described herein.

As used herein, the term “starch” refers to a natural polysaccharide that includes amylose and amylopectin in various ratios and derivatives thereof. Example of starches may include, but are not limited to, waxy starches, modified starches, native starches, dextrins, and maltodextrins with dextrose equivalents of 1-50. In some embodiments, a starch described herein may have an amylose content of about 30% or less, 25% or less, or 10% or less. In some instances, a starch described herein may have an amylose content of about 1% or less.

In some embodiments, starch esters may be present in liquid adhesives described herein in an amount ranging from a lower limit of about 0.1%, 1%_{,} 3%, 5%, or 10% by weight of the liquid adhesive to an upper limit of about 30%, 20%, 15%, or 10% by weight of the liquid adhesive, wherein the amount may range from any lower limit to any upper limit and encompass any subset therebetween.

Starch esters suitable for use in conjunction with the liquid adhesives described herein may be derived from any suitable starch source. Native, modified, waxy, modified waxy, and hydrolyzed starches can be used. Suitable starch sources may, in some embodiments, include, but are not limited to, cereals, rice, wheat, maize, root vegetables, potatoes, corn, tapioca, cassava, acorns, arrowroot, arracacha, bananas, barley, breadfruit, buckwheat, canna, colacasia, katakuri, kudzu, malanga, millet, oats, oca, polynesian arrowroot, sago, sorghum, sweet potatoes, rye, taro, chestnuts, water chestnuts, yams, beans, favas, lentils, mung beans, peas, chickpeas, and the like, and any combination thereof.

Starch esters may, in some embodiments, have ester substituents that include, but are not limited to, C₁-C₂₀ aliphatic esters (e.g., acetate, propionate, or butyrate), functional C₁-C₂₀ aliphatic esters (e.g., acrylates or diesters), aromatic esters (e.g., benzoate or phthalate), substituted aromatic esters, and the like, any derivative thereof, and any combination thereof.

In some embodiments, the starch esters may be bio-derived where not only the starch source is from a biological source, but also the acid or other reactants used to derivatize the starch. For example, acetic anhydride can be produced from a bio-derived acetic acid.

Starch esters suitable for use in conjunction with the liquid adhesives described herein may, in some embodiments, have a degree of substitution of the substituent ranging from a lower limit of about 0.5, 1.2, or 2 to an upper limit of about 3, 2.9, 2.7, or 2.5, and wherein the degree of substitution may range from any lower limit to any upper limit and encompass any subset therebetween.

Starch esters suitable for use in conjunction with the liquid adhesives described herein may, in some embodiments, have a molecular weight ranging from a lower limit of about 1,000, 15,000, or 25,000 to an upper limit of about 80,000, 50,000, or 30,000, and wherein the molecular weight may range from any lower limit to any upper limit and encompass any subset therebetween.

Plasticizers suitable for use in conjunction with the liquid adhesives described herein may, in some embodiments, include, but are not limited to,

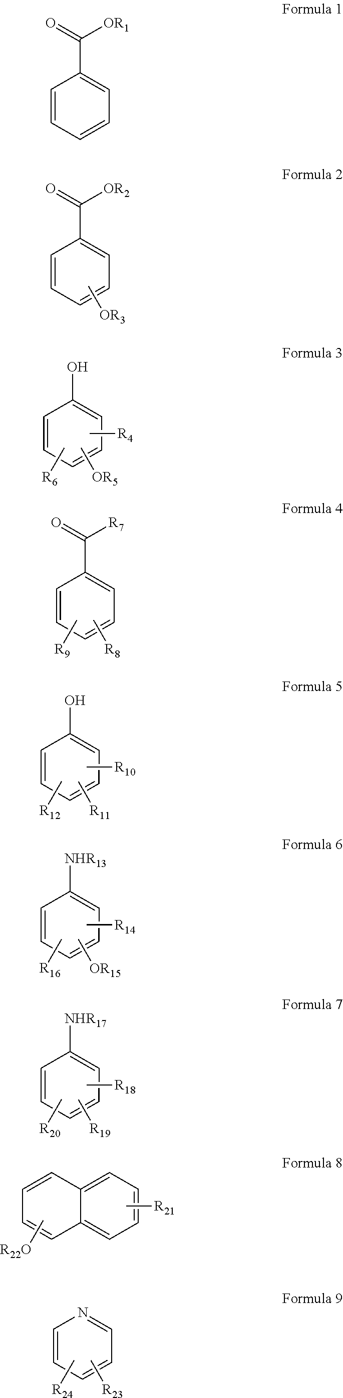

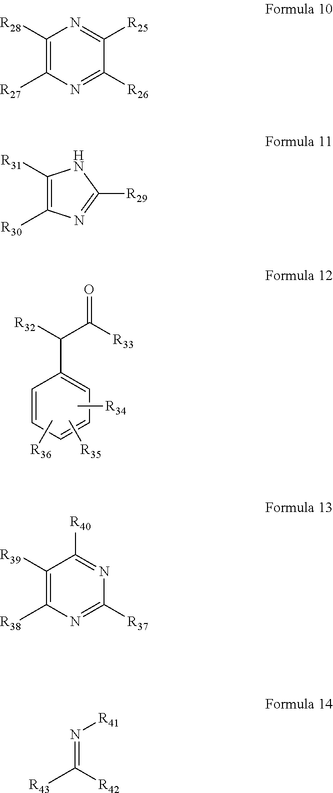

Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R44HN—R45-NHR46 where R44 and R46 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R45 is C₁-C₁₀ alkyl; and combinations thereof. As used herein, “alkyl” refers to a substituent with C and H that may be linear or branched (e.g., t-butyl) and saturated or unsaturated. As used herein, “aryl” refers to an aromatic ring that may include phenyl, naphthyl, and aromatic rings with heteroatoms.

Examples of plasticizers suitable for use in conjunction with the liquid adhesives described herein may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenozoate, methyl-4-hydroxybenozoate, ethyl-4-hydroxybenozoate, benzyl-4-hydroxybenozoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

Additional examples of plasticizers suitable for use in conjunction with the liquid adhesives described herein may, in some embodiments, be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. It has been discovered that some nonionic surfactants plasticize cellulose and starch esters, alone or in combination with small molecule plasticizers. This is unexpected because traditional plasticizers are small molecules. By contrast, nonionic surfactants are bulky with long hydrocarbon tail groups and potentially large head groups. For example, polyoxyethylene (20) sorbitan monolaurate, which is significantly larger than traditional cellulose ester plasticizers like triacetin, has been observed to plasticize cellulose ester.

In some embodiments, the plasticizers may be food-grade plasticizers, which may be useful in producing adhesives described herein for use in applications where the adhesive may directly or indirectly contact food (e.g., food containers). Examples of food-grade plasticizers may, in some embodiments, include, but are not limited to, triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and the like, and any combination thereof.

In some embodiments, the plasticizers may be bio-derived, which may be useful in producing adhesive compositions that are bio-derived. For example, bio-derived triacetin, diacetin, tripropionin, glyceryl esters, may be produced from glycerol that is a byproduct of biodiesel. Other examples of plasticizers that may be bio-derived may include, but are not limited to, vanillin, acetovanillone, γ-valerolactone, eugenol, epoxidized soybean oil, castor oil, linseed oil, epoxidized linseed oil, and dicarboxylic esters (e.g., dimethyl adipate, dibutyl maleate). In some instances, aroma plasticizers may be extracts from natural products, and therefore, bio-derived plasticizers.

In some embodiments, the plasticizers may be semi-volatile to volatile plasticizers. Examples of some preferred semi-volatile to volatile plasticizers may include, but are not limited to, glycerol esters, (e.g., triacetin, diacetin, monoacetin), ethylene glycol diacetate, alkyl lactones (e.g., γ-valerolactone), dibutyl maleate, di-octyl maleate, dibutyl tartrate, eugenol, tributyl phosphate, tributyl-o-acetyl citrate, and resorcinol monoacetate.

In some instances, two or more plasticizers may be used in liquid adhesives composition. In some instances, it has been surprisingly observed that two or more plasticizers may have synergistic effects. For the same total weight percent of total plasticizer, a liquid adhesive with multiple plasticizers may have a lower viscosity than a liquid adhesive with the individual plasticizers alone, which is an unexpected observation.

In some embodiments, the liquid adhesives described herein may further comprise additives. Additives suitable for use in conjunction with the liquid adhesives described herein may include, but are not limited to, diluents, solvents, set time modifiers, tackifiers, crosslinkers, insolubilizers, fillers, water-resistance additives, flame retardants, lubricants, softening agents, antibacterial agents, antifungal and/or antimicrobial agents, preservatives, flow modifiers, pigments, dyes, antioxidants, UV-stabilizers, flowing agents, aromas, and the like, and any combination thereof.

In some embodiments, the additives may be present in liquid adhesives described herein in an amount ranging from a lower limit of about 0.1%, 1%_{,} 5%, or 10% by weight of the liquid adhesive to an upper limit of about 70%, 50%, 20%, or 10% by weight of the liquid adhesive, wherein the amount may range from any lower limit to any upper limit and encompass any subset therebetween.

Diluents and solvents may, in some embodiments, decrease the viscosity of the liquid adhesive. Diluents are generally miscible with some components of the liquid adhesive (e.g., a plasticizer or a set time modifier) and suspend the cellulose ester, the starch ester, or both. Whereas solvents generally dissolve the cellulose ester, the starch ester, or both and are at least partially miscible with the other components of the liquid adhesive. The distinction between diluent and solvent may depend on, inter alia, the ester functionality of the cellulose or starch ester, the molecular weight of the cellulose or starch ester, the degree of substitution of the cellulose or starch ester, and the like. Examples of diluents and solvents suitable for use in the liquid adhesives described herein may include, but are not limited to, dimethyl sulfoxide (“DMSO”), dimethyl formamide (“DMF”), ethyl acetate, methanol, ethanol, glycerol, glycol ethers, glycol esters, glycol ester ethers, isopropyl alcohol, ethylene glycol, polyethylene glycol (e.g., polyethylene glycol 300 molecular weight (“PEG-300”)), propylene glycol, nonionic surfactants, and the like, and any combination thereof. In some instances, water may be a diluent or solvent where the amount of water is consistent with the degree of ester substitution of the cellulose ester to mitigate precipitation of the cellulose ester from the liquid adhesive.

In some embodiments, diluents and solvents suitable for use in conjunction with the liquid adhesives described herein may be food-grade diluents and food-grade solvents, respectively. Examples of food-grade diluents and food-grade solvents may, in some embodiments, include, but are not limited to, methanol, ethanol, glycerol, isopropyl alcohol, polyethylene glycol, nonionic surfactants, and the like, and any combination thereof.

Set time modifiers may, in some embodiments, be used to increase or decrease the time for the liquid adhesive to dry (described further herein). Examples of set time modifiers suitable for decreasing the set time of the liquid adhesives described herein may include, but are not limited to, glycerin, polyethylene glycol, nonionic surfactants, and the like, and any combination thereof.

In some embodiments, set time modifiers suitable for use in conjunction with the liquid adhesives described herein may be food-grade set time modifiers. Examples of food-grade set time modifiers may, in some embodiments, include, but are not limited to, glycerin, polyethylene glycol, nonionic surfactants, and the like, and any combination thereof.

Tackifiers may, in some embodiments, increase the adhesive properties of the liquid adhesives described herein. Tackifiers suitable for use in conjunction with the liquid adhesives described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, rosin esters, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, ethylene vinyl acetate, vinyl acetate ethylene polymers, aliphatic hydrocarbons, cycloaliphatic hydrocarbons, aromatic hydrocarbons, aromatically modified aliphatic hydrocarbons, cycloaliphatic hydrocarbons, hydrogenated versions of the foregoing hydrocarbons, terpenes, polyterpenes, modified terpenes (e.g., phenolic modified terpene resins), and the like, any derivative thereof, and any combination thereof.

In some embodiments, tackifiers suitable for use in conjunction with the liquid adhesives described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

In some embodiments, compatibilizers may be used to more homogeneously incorporate tackifying resins into an adhesive described herein. Exemplary compatibilizers for use in conjunction with the liquid adhesives described herein may be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. Additional exemplary compatibilizers for use in conjunction with the liquid adhesives described herein may be polymers that include, but are not limited to, polyethylene glycol less than about 2000 molecular weight. Combinations of the foregoing may also be used. In some embodiments, compatibilizers may be present in the liquid adhesives described herein in an amount of about 0.5% to about 20% by weight of the adhesives composition.

Crosslinkers may, in some embodiments, increase the adhesive properties and/or increase water-resistance of the liquid adhesives described herein. Crosslinkers suitable for use in conjunction with the liquid adhesives described herein may, in some embodiments, include, but are not limited to, zirconium salts, boric acid, borate salts, ammonium zirconium carbonate, potassium zirconium carbonate, metal chelates (e.g., zirconium chelates, titanium chelates, or aluminum chelates), formaldehyde crosslinkers, polyamide epichlorohydrin resin, crosslinkers containing N-methylol groups and/or etherified N-methylol groups (e.g., ARKOFIX® (an ultra-low formaldehyde crosslinking agent, available from Clariant)), glyoxal, urea glyoxal adduct crosslinkers, urea formaldehyde adduct crosslinkers, melamine formaldehyde, 4,5-dihydroxy-N,N′-dimethylolethyleneurea, hydroxymethylated cyclic ethyleneureas, hydroxymethylated cyclic propyleneureas, hydroxymethylated bicyclic glyoxal diurea, hydroxymethylated bicyclic malonaldehyde diureas, dialdehydes, protected dialdehydes, bisulfite protected aldehydes, isocyanates, blocked isocyanates, dimethyoxytetrahydrafuran, dicarboxylic acids, epoxides, diglycidyl ether, hydroxymethyl-substituted imidazolidinone, 1,3-dimethylol-4,5-dihydroxyimidazolidinone, hydroxymethyl-substituted pyrimidinones, hydroxymethyl-substituted triazinones, epoxides, epoxidized natural oils (e.g., epoxidized soy oil or expoxidized linseed oil), oxidized starch, oxidized polysaccharides, oxidized hemicellulose, and the like, any derivative thereof, and any combination thereof. One skilled in the art with the benefit of this disclosure should understand that formaldehyde crosslinkers should be excluded from use in conjunction with formaldehyde-free liquid adhesives, and limited in substantially formaldehyde-free liquid adhesives (i.e., the liquid adhesive comprising less than 0.01% formaldehyde by weight of the liquid adhesive). In some embodiments, crosslinkers suitable for use in conjunction with the liquid adhesives described herein may be food-grade crosslinkers.

Water-resistance additives may, in some embodiments, increase the water-resistance properties of the liquid adhesives described herein, which may consequently yield articles capable of maintaining their mechanical properties in environments with higher water concentrations, e.g., humid environments. Water-resistance additives suitable for use in conjunction with the liquid adhesives described herein may, in some embodiments, include, but are not limited to, waxes, polyolefins, insolublizers, ethylene vinyl acetate, vinyl acetate ethylene polymers, octenyl succinyls, alkenyl succinyls, and the like, and any combination thereof.

In some embodiments, water-resistance additives suitable for use in conjunction with the liquid adhesives described herein may be food-grade water-resistance additives. Examples of food-grade water-resistance additives may, in some embodiments, include, but are not limited to, waxes, polyolefins, ethylene vinyl acetate, vinyl acetate ethylene polymers, and the like, and any combination thereof.

Fillers may, in some embodiments, increase the rigidity of the liquid adhesives described herein, which may consequently increase the mechanical rigidity of an article produced therewith. Fillers suitable for use in conjunction with the liquid adhesives described herein may, in some embodiments, include, but are not limited to, coconut shell flour, walnut shell flour, wood flour, wheat flour, soybean flour, gums, starches, protein materials, calcium carbonate, talc, zeolite, clay, rigid compounds (e.g. lignin), thickeners, and the like, and any combination thereof.

In some embodiments, fillers suitable for use in conjunction with the liquid adhesives described herein may be food-grade fillers. Examples of food-grade fillers may, in some embodiments, include, but are not limited to, coconut shell flour, walnut shell flour, wood flour, wheat flour, soybean flour, gums, starches, protein materials, calcium carbonate, and the like, and any combination thereof.

Flame retardants suitable for use in conjunction with the liquid adhesives described herein may, in some embodiments, include, but are not limited to, silica, metal oxides, phosphates, catechol phosphates, resorcinol phosphates, aromatic polyhalides, borates, inorganic hydrates, and the like, and any combination thereof.

Antifungal and/or antimicrobial agents suitable for use in conjunction with the liquid adhesives described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, octynoic acid, and any combination thereof.

Preservatives suitable for use in conjunction with a liquid adhesive described herein may, in some embodiments, include, but are not limited to, benzoates, parabens (e.g., the propyl-4-hydroxybenozoate series), and the like, and any combination thereof.

Flow modifiers may, in some embodiments, change the rheology of the liquid adhesive with minimal to no impact on the glass transition temperature. Flow modifiers may be useful in reducing or eliminating defects (e.g., pinholes, craters, orange peel, and the like) observed when applying or producing a film of a liquid adhesive to a surface. Examples of flow modifiers suitable for use in conjunction with the liquid adhesives described herein may, in some embodiments, be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof.

Pigments and dyes suitable for use in conjunction with the liquid adhesives described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with the liquid adhesives described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of the liquid adhesives described herein during storage, transportation, and/or implementation. Antioxidants suitable for use in conjunction with the liquid adhesives described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with the liquid adhesives described herein may be food-grade antioxidants. Examples of food-grade antioxidants may, in some embodiments, include, but are not limited to, ascorbic acid, vitamin A, tocopherols, tocopherol esters, beta-carotene, flavonoids, and the like, and any combination thereof.

Aromas suitable for use in conjunction with the liquid adhesives described herein may, in some embodiments, include, but are not limited to, spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vannillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, benzoin, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In some embodiments, liquid adhesives described herein may be food-grade liquid adhesives that comprise food-grade cellulose or starch esters and food-grade plasticizers and optionally further comprise food-grade additives.

In some instances, a component of a liquid adhesive described herein may perform more than one function in the liquid adhesive described herein. For example, BHT and BHA are both antioxidants and plasticizers for cellulose esters, starch esters, or both. In another example, aromas like eugenol, cinnamyl alcohol, camphor, methoxy hydroxy acetophenone (acetovanillone), vanillin, and ethylvanillin may also plasticize cellulose esters, starch esters, or both. In yet another example, benzoates and parabens (e.g., the propyl-4-hydroxybenozoate series) may be both preservatives and plasticizers for cellulose esters, starch esters, or both.

In some embodiments, liquid adhesives described herein may be at least in part bio-derived adhesive compositions. In some embodiments, the amount of the adhesive composition that is bio-derived may range from a lower limit of about 2%, 5%, 10%, 25%, 50%, 75%, or 90% to an upper limit of about 100%, 99%, 95%, 90%, 75%, or 50%, and wherein the amount of the adhesive composition that is bio-derived may range from any lower limit to any upper limit and encompasses any subset therebetween.

In some embodiments, the liquid adhesives described herein may comprise plasticizers (e.g., one or more specific plasticizers describe herein, food-grade plasticizers described herein, aroma plasticizers described herein, and a combination thereof) and cellulose esters, starch esters, or both (e.g., having an ester substituent described herein, a degree of substitution described herein, a molecular weight described herein, from a cellulosic source described herein, and a combination thereof) and optionally additives described herein (e.g., one or more specific additives describe herein, at amounts described herein, and a combination thereof).

In some embodiments, tailoring the dynamic viscosity of the liquid adhesives described herein may be achieved by, inter alia, changing the plasticizer composition, changing the plasticizer concentration (e.g., increasing the concentration to decrease the dynamic viscosity), and changing the molecular weight of the cellulose esters, starch esters, or both (e.g., decreasing molecular weight to decrease the dynamic viscosity).

In some embodiments, the liquid adhesives described herein may have a dynamic viscosity of about 100 Pa·s or less at 25° C. and a shear rate of 40 s⁻¹. In some embodiments, the liquid adhesives described herein may have a dynamic viscosity at 25° C. and a shear rate of 40 s⁻¹ ranging from a lower limit of about 0.1 Pa·s, 1 Pa·s, or 10 Pa·s to an upper limit of about 100 Pa·s, 50 Pa·s, or 25 Pa·s, and wherein the dynamic viscosity may range from any lower limit to any upper limit and encompass any subset therebetween.

In some embodiments, tailoring the adhesive strength of the liquid adhesives described herein may be achieved by, inter alia, changing the plasticizer composition, changing the plasticizer concentration (e.g., increasing the concentration to decrease the adhesive strength), and changing the molecular weight of the cellulose esters, starch esters, or both (e.g., decreasing molecular weight to decrease the adhesive strength).

The adhesive strength of liquid adhesives described herein may be measured by peel adhesion and/or lap shear strength testing mechanisms.

Peel adhesion can be measured by ASTM 3330/D Method A (Standard test method for peel adhesion of PSA tape (“180° Peel”)) and tested on a surface of interest (e.g., corrugated cardboard, glass, stainless steel panels). Test method A gives a measure of the adherence, when peeled at 180° angle, to a standard steel panel or to other surfaces of interest (e.g., corrugated board or glass) for a single-coated tape. This test method provides a means for assessing the uniformity of the adhesion of a given type of adhesive. In this method, a strip is applied to a standard test panel (or other surface of interest) with controlled pressure. The tape is peeled from the panel at 180° angle at a specified rate with a 1 kN load cell, during which the force required to effect peel is measured.

In some embodiments, a liquid adhesive described herein may have a peel adhesion (using with a 4 mil coated paper backing) ranging from a lower limit of about 0.1 lb/in, 0.25 lb/in, 0.5 lb/in, or 1 lb/into an upper limit of about 5 lb/in, 3 lb/in, 1 lb/in, and wherein the peel adhesion may range from any lower limit to any upper limit and encompass any subset therebetween. Depending on the substrate, in some instances, the substrate may fail (e.g., tear) before failure of the liquid adhesive described herein.

The lap shear strength of a liquid adhesive described herein can be measured by testing lap shears by tension loading with a 1 kN load cell by a method that includes placing a specimen (two substrates with a 1 inch by 1 inch overlap and 3 mm thick glue line) in the grips of the testing machine so that each end of the specimen is in contact with the grip assembly, applying the loading immediately to the specimen at the rate of 800 lb force of shear per min, and continuing the load to failure of the adhesive or substrate. Adhesive failure is recorded as the lap shear strength, and substrate failure is recorded as substrate failure. In some instances, substrate failure for a 4 mil coated paper has been observed at about 17 kgf. This value may change depending on the substrate and size of the glue line.

In some embodiments, a liquid adhesive described herein may have a lap shear strength (using with a 4 mil coated paper backing) ranging from a lower limit of about 0.2 kgf, 0.5 kgf, 1 kgf, 2 kgf, 4 kgf, or 6 kgf to an upper limit of about 17 kgf, 15 kgf, 10 kgf, 8 kgf, 6 kgf, or 4 kgf, and wherein the lap shear strength may range from any lower limit to any upper limit and encompass any subset therebetween. In some instances, the 4 mil coated paper may fail before the liquid adhesive described herein fails. In some embodiments, a liquid adhesive described herein may have a lap shear strength (using an aluminum or stainless steel substrate) ranging from a lower limit of about 0.2 kgf, 0.5 kgf, 1 kgf, 2 kgf, 5 kgf, or 10 kgf to an upper limit of about 30 kgf, 20 kgf, 15 kgf, or 10 kgf, and wherein the lap shear strength may range from any lower limit to any upper limit and encompass any subset therebetween.

Tailoring the set time of liquid adhesives described herein may be advantageous in the production, especially high-speed production, of products and articles. In some embodiments, tailoring the set time of the liquid adhesives described herein may be achieved by, inter alia, changing the plasticizer composition, changing the plasticizer concentration (e.g., increasing the concentration to increase the set time), and changing the composition and/or concentration of additives (e.g., increasing set time additives to decrease the set time or increasing solvent/diluent to increase the set time).

The set time for the adhesive may be measured by rolling a 4 mil tipping paper around a 7.8 mm diameter rod with the liquid adhesive at the seam line and measuring the time necessary to apply 0.5 lbs of pressure such that upon release of pressure the seam does not butterfly (i.e., open).

In some embodiments, the liquid adhesives described herein may have a room temperature set time ranging from a lower limit of about 1 sec, 2 sec, 5 sec, 10 sec, or 30 sec to an upper limit of about 10 min, 5 min, 2 min, 1 min, or 30 sec, wherein the room temperature set time may range from any lower limit to any upper limit and encompass any subset therebetween. In some instances, during production of products and articles, the temperature of the liquid adhesive may be increased (e.g., during application or after application) to hasten drying.

Tailoring the degradability of liquid adhesives described herein may contribute to the overall degradability of products and articles comprising the liquid adhesives. In some embodiments, tailoring the degradability of the liquid adhesives described herein may be achieved by, inter alia, changing the plasticizer composition (e.g., utilizing a plasticizer that biodegrades or dissipates into the environment at a higher rate to increase the degradability), changing the plasticizer concentration (e.g., increasing the concentration to increase the degradability), changing the degree of substitution of the cellulose esters, starch esters, or both (e.g., decreasing the degree of substitution to increase the degradability), and changing the composition and/or concentration of additives (e.g., increasing antioxidant and/or stabilizer concentration to decrease the degradability).

In some embodiments, the liquid adhesives described herein may degrade to a greater extent than a cellulose diacetate material plasticized with 20% triacetin. In some embodiments, the liquid adhesives may degrade by about 5% or greater by weight than a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging.” In some embodiments, the liquid adhesives may degrade by an amount ranging from a lower limit of about 5%, 10%, or 15% to an upper limit of about 300%, 200%, 100%, 50%, 40%, or 30% by weight than a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging,” and wherein the degradation may range from any lower limit to any upper limit and encompass any subset therebetween. In some instances, the comparative rate of degradation may be outside the ranges described herein depending on the concentration of the plasticizer, the composition of the plasticizer, and the composition of the cellulose ester.

The clarity of the liquid adhesives described herein may be important in some applications, e.g., high clarity (or low haze) may be necessary when the liquid adhesives are used in conjunction with high clarity (or low haze) substrates (e.g., CLARIFOIL®, glass, or high clarity polymer films). In some embodiments, tailoring the clarity of the liquid adhesives described herein may be achieved by, inter alia, changing the plasticizer concentration (e.g., increasing the concentration to increase the clarity/decrease the haze).

In some embodiments, the liquid adhesives described herein may have a haze ranging from a lower limit of about 2, 5, 7, 10, 15, 20, or 25 to an upper limit of about 45, 40, 35, 30, or 25, and wherein the haze may range from any lower limit to any upper limit and encompass any subset therebetween. The haze of a liquid adhesive can be measured with properly sized specimens having substantially plane-parallel surfaces (e.g., flat without wrinkling) free of dust, scratches, particles and a thickness of about 0.85 mm using an UtraScan Pro from Hunter Lab with D65 Illuminant/10° observer. One skilled in the art with the benefit of this disclosure would understand that the haze value may fall outside the preferred ranges described herein for different thickness of a liquid adhesive sample. In some instances, the haze value may be significantly larger than the preferred ranges above (e.g., about 100) when additives like titanium dioxide are used in significant quantities to produce an opaque liquid adhesive. Additionally, pigments and dyes may affect the haze of the liquid adhesive. Accordingly, within the scope of the embodiments described herein, the haze may range from about 2 to about 100, including subsets therebetween, depending on the composition and concentration of additives included in the liquid adhesives.

Some embodiments described herein may involve producing liquid adhesives described herein, which may involve compounding (or otherwise mixing) cellulose esters, starch esters, or both with plasticizers described herein at a suitable concentration, which may optionally involve heating. In some instances, compounding may involve high-shear mixing processes, which may optionally involve heating. In some embodiments, additives may be incorporated into liquid adhesives by inclusion in the compounding or other mixing step.

Some embodiments may involve applying a liquid adhesive described herein to a surface of a substrate and drying the adhesive thereon. In some embodiments, the dried adhesive may be tacky. For example, in some instances, a liquid adhesive described herein may be applied to paper and dried so as to form a layer of a PSA thereon. The paper may then be assembled so as to form a stack of sticky-notes or other repositionable product. In some embodiments, the dried adhesive may be non-tacky. For example, in some instances, a liquid adhesive described herein may be applied to paper and dried so as to form a non-tacky layer thereon. In some instances, the components of the liquid adhesive may be such that the dried non-tacky layer has high clarity and resembles a laminate film on the paper.

Some embodiments may involve applying a liquid adhesive described herein to a first surface and adhering a second surface thereto. For example, a substrate may be rolled into a cylinder where a liquid adhesive is applied to a first surface of the substrate and adhered to a second surface of the substrate so as to maintain the substrate in the cylindrical shape. In another example, a liquid adhesive may be applied to a first substrate (e.g., around the outer portions of a CLARIFOIL® substrate) and adhered to a second substrate (e.g., a cardboard or other paper product box in a corresponding cutout or hole) to form a product (e.g., a container with a CLARIFOIL® view window).

In some instances, the liquid adhesive may be applied with a nozzle. In some instances, the liquid adhesive may be applied with a roll.

In some instances, the liquid adhesive may be applied to a surface at a speed ranging from a lower limit of about 1 m/min, 10 m/min, or 50 m/min to an upper limit of about 300 m/min, 200 m/min, or 100 m/min, and wherein the application speed may range from any lower limit to any upper limit and encompass any subset therebetween.

In some instances, the liquid adhesive may be applied at a temperature ranging from a lower limit of about 25° C., 35° C., or 50° C. to an upper limit of about 100° C., 75° C., or 50° C., and wherein the temperature may range from any lower limit to any upper limit and encompass any subset therebetween. In some instances, the liquid adhesive after application to a surface (and optionally after adherence to a second surface) may be heated to a temperature ranging from a lower limit of about 25° C., 35° C., or 50° C. to an upper limit of about 100° C., 75° C., or 50° C., and wherein the temperature may range from any lower limit to any upper limit and encompass any subset therebetween. In some embodiments, a combination of the foregoing may be implemented where the application and post-application temperatures may be the same or different.

Some embodiments may involve capturing a portion of the volatile components of the liquid adhesive after application to the surface, which may optionally be recycled for use in the production of more liquid adhesive. Examples of volatile components of the liquid adhesive may include, but are not limited to, diluents, solvents, and plasticizers.

Exemplary examples of articles described herein comprising liquid adhesives described herein may, in some embodiments, include, but are not limited to, smoking articles (e.g., cigarettes), envelopes, tape, cardboard packaging (e.g., mailing packages and food containers like cereal boxes and frozen dinner containers), books, notebooks, magazines, sticky-notes, corrugated boxes, decorative boxes, paper bags, grocery bags, wrapping paper, wallpaper, paper honeycomb, emery boards, electric insulation paper, air filters, papier-mâché articles, carpets, dartboards, furniture or components thereof (e.g., carpet and/or fabric coated headboards, chairs, and stools), picture frames, medical garments (e.g., disposable gowns and surgical masks), bandages, therapeutic patches, feminine hygiene products, diapers, shoes, clothing (e.g., binding), glues for labels (e.g., self-adhesive labels and HM or HMPSA glues for labels (e.g., replacing casein glues)), self-adhesive stamps, self-adhesive window covering films (e.g., protective films for glass or other substrates), self-adhesive window coverings (e.g., decorative window stickers, window films, and window tinting), heat activated films, light films, light filters, iron-on designs, substrates with laminated surfaces (e.g., laminated paper, laminated business cards, a laminated paper board, or a protective covering directly laminated onto a surface like glass), a coated substrate, and the like.

Substrates or surfaces suitable for use in conjunction with articles described herein may, in some embodiments, include, but are not limited to, fibers, woven fiber substrates, nonwoven fiber substrates, foamed substrates, solid substrates, and the like, any hybrid thereof, and any combination thereof.

Substrates or surfaces suitable for use in conjunction with articles described herein may, in some embodiments, comprise materials that include, but are not limited to, ceramics, natural polymers, synthetic polymers, metals, natural materials, carbons, and the like, and any combination thereof. Examples of ceramics may, in some embodiments, include, but are not limited to, glass, quartz, silica, alumina, zirconia, carbide ceramics, boride ceramics, nitride ceramics, and the like, and any combination thereof. Examples of natural polymers may, in some embodiments, include, but are not limited to, cellulose, and the like, any derivative thereof, and any combination thereof. Examples of synthetic polymers may, in some embodiments, include, but are not limited to, cellulose diacetate, cellulose triacetate, synthetic bamboo, rayon, acrylic, aramid, nylon, polyolefins, polyethylene, polypropylene (including biaxially oriented polypropylene substrates), polyethylene terephthalate, polyesters, polyamides, zylon, and the like, any derivative thereof, and any combination thereof. Examples of metals may, in some embodiments, include, but are not limited to, steel, stainless steel, aluminum, copper, and the like, any alloy thereof, and any combination thereof. Examples of natural materials may, in some embodiments, include, but are not limited to, wood, grass, animal hide, and the like, and any combination thereof. Examples of carbons may, in some embodiments, include, but are not limited to, carbon fibers, and the like, any derivative thereof, and any combination thereof.

Exemplary examples of substrates suitable for use in conjunction with the articles described herein may, in some embodiments, include, but are not limited to, paper, cardboard, card stock, sand paper, bond paper, wallpaper, wrapping paper, cotton paper, tipping paper, bleached paper, colored paper, construction paper, sisal paper, coated paper, wax paper, CLARIFOIL® (cellulose diacetate film, available from Celanese Corporation), woven fabrics, continuous filament nonwoven fabrics, carded nonwoven fabrics, tow, fiber bundles, twill, twine, rope, carpet, carpet backing, leather, animal hide, insulation, wood and/or grass derived substrates (e.g., wood veneers, particle board, fiberboard, medium-density fiberboard, high-density fiberboard, oriented strand board, cork, hardwoods (e.g., balsa wood, beech, ash, birch, Brazil wood, cherry, chestnut, elm, hickory, mahogany, maple, oak, rosewood, teak, walnut, locust, mango, alder, and the like), softwoods (e.g., pine, fir, spruce, cedar, hemlock, and the like), rough lumber, finished lumber, natural fibrous material, and bamboo), foam substrates (e.g., memory foams, polymer foams, polystyrene foam, polyurethane foam, frothed polyurethane, and soy-based foams), and the like, and any combination thereof.

By way of nonlimiting example, an article (e.g. a labelled bottle) may comprise a first surface (e.g., a plastic or glass container) to which a liquid adhesive may be applied for use in adhering a second surface (e.g., a paper label, a plastic label, or a CLARIFOIL® label) to the first surface. In some instances, the liquid adhesive may be on the second surface before application to the first surface. The liquid adhesive may have unique advantages in relation to recycling of the bottles. For example, the components of at least some of the liquid adhesives described herein are compatible with the current plastic recycling technologies (which allows for a 100% recyclable bottle) and glass bottle washing technologies (which allows for labels to be removed in a caustic bath without additional steps and cost). Other technologies that provide this benefit includes some emulsion adhesives, however, as described above, their application when producing labeled bottles is more energy and labor intensive. Therefore, the adhesive compositions described herein provide for a more environmentally friendly adhesive from production (i.e., from natural products) to application to recycling.

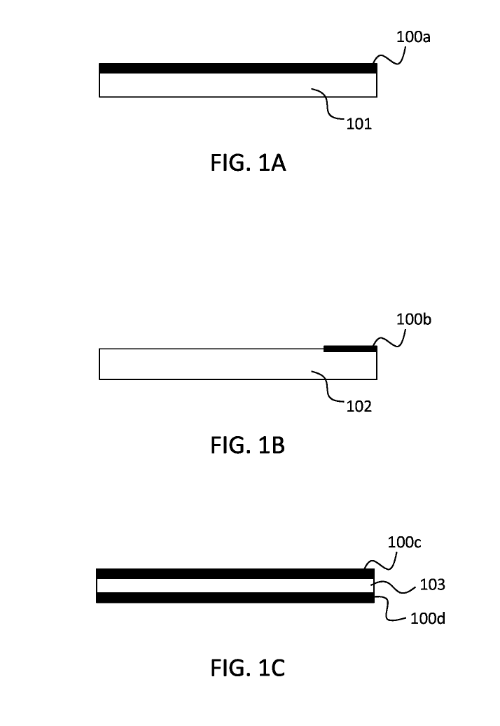

In some embodiments, the articles described herein may be designed with the adhesive applied to a surface in any suitable configuration (e.g., as a laminate). Examples of suitable configurations may, in some embodiments, include, but are not limited to, those illustrated in FIG. 1. FIG. 1A illustrates a substrate 101 with an adhesive 100a covering a surface of the substrate 101. FIG. 1B illustrates a substrate 102 with an adhesive 100b covering a portion a surface of the substrate 102. Such configurations may be useful in producing articles like sticky notes and other repositionable articles. FIG. 1C illustrates a substrate 103 with a first adhesive 100c covering a surface of the substrate 103 and a second adhesive 100d covering an opposing surface of the substrate 103. In some instances, the first and second adhesives 100c,d may be different. For example, first adhesive 100c may be tacky at room temperature, and second adhesive 100d may be non-tacky at room temperature and provide a protective coating to substrate 103.

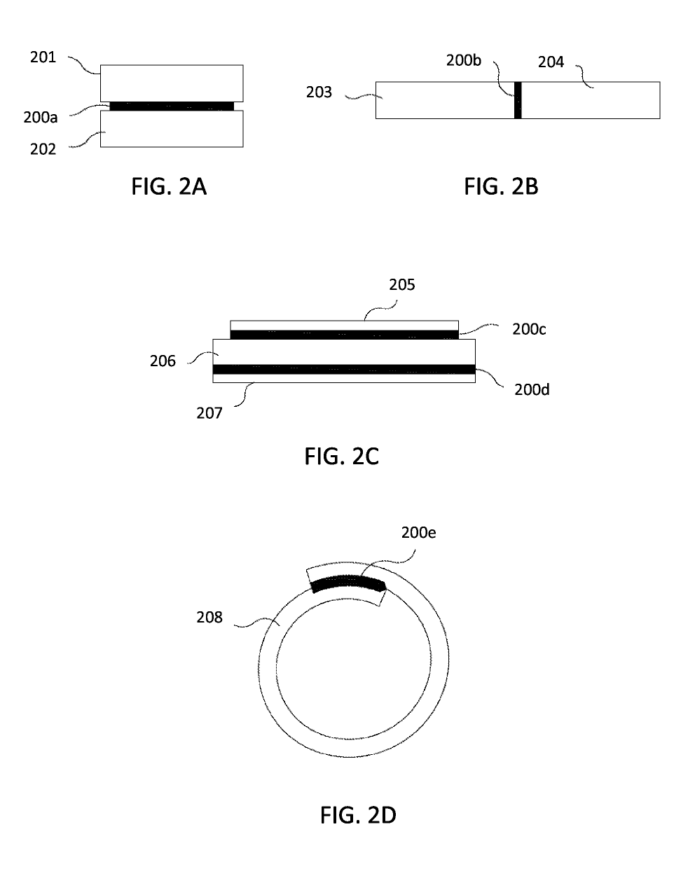

In some embodiments, the articles described herein may be designed with the first surface and the second surface adhered in any suitable configuration. Examples of suitable configurations may, in some embodiments, include, but are not limited to, those illustrated in FIG. 2. FIG. 2A illustrates a first substrate 201 and a second substrate 202 adhered together with an adhesive described herein 200a in a stacked configuration. FIG. 2B illustrates a first substrate 203 and a second substrate 204 adhered together an adhesive described herein 200b in a side-by-side configuration. FIG. 2C illustrates a first substrate 205, a second substrate 206, and a third substrate 207 adhered together with an adhesive described herein 200c,200d in a stacked configuration where each substrate 205,206,207 has different sizes. FIG. 2D illustrates a substrate 208 rolled and adhered to itself at a seam with an adhesive described herein 200e.

One skilled in the art with the benefit of this disclosure should recognize that FIGS. 1-2 are merely examples of possible configurations of articles described herein and that a multitude of other configurations are possible and within the bounds of this disclosure.

Embodiments disclosed herein include:

Embodiment A: an adhesive that includes: a cellulose ester, a starch ester, or both at about 1% to about 30% by weight of the adhesive; and a plasticizer, wherein the adhesive has a dynamic viscosity of about 100 Pa·s or less at 25° C. and a shear rate of 40 s⁻¹;

Embodiment B: an article comprising the adhesive of Embodiment A disposed on a substrate;

Embodiment C: a method that includes: applying an adhesive to a first surface moving at a speed of about 1 m/min to about 800 m/min (or about 100 m/min to about 800 m/min), the adhesive comprising a plasticizer and a cellulose ester, a starch ester, or both with the cellulose ester, the starch ester, or both at about 1% to about 30% by weight of the adhesive, and wherein the adhesive has a dynamic viscosity of about 100 Pa·s or less at 25° C. and a shear rate of 40 s⁻¹, and adhering a second surface to the first surface with the adhesive.

Each of embodiments A, B, and C may have one or more of the following additional elements in any combination: Element 1: wherein the plasticizer is at about 20% to about 97% by weight of the adhesive; Element 2: wherein the plasticizer is at about 40% to about 97% by weight of the adhesive; Element 3: wherein the plasticizer is at about 80% to about 97% by weight of the adhesive; Element 4: the adhesive further including a set time modifier at about 0.1% to about 30% by weight of the adhesive; Element 5: the adhesive further including a diluent or a solvent at about 0.1% to about 70% by weight of the adhesive; Element 6: wherein the adhesive consists essentially of the plasticizer and the cellulose ester, the starch ester, or both; Element 7: wherein the adhesive consists essentially of (1) the cellulose ester, the starch ester, or both, (2) the plasticizer, and (3) at least one selected from the group consisting of a diluent, a solvent, a set time modifier, a tackifier, a crosslinker, an insolubilizer, a filler, a water-resistance additive, a flame retardant, a lubricant, a softening agent, an antibacterial agent, an antifungal and/or antimicrobial agent, a preservative, a flow modifier, a pigment, a dye, an antioxidant, a UV-stabilizer, a flowing agent, an aroma, and any combination thereof; Element 8: wherein the cellulose ester, the starch ester, or both have a degree of substitution between about 0.5 and less than about 3; Element 9: wherein the cellulose ester has a molecular weight between about 10,000 and about 300,000; and Element 10: wherein the substrate, the first surface, the second surface, or a combination thereof is a cellulose diacetate film.

By way of non-limiting example, exemplary combinations applicable to Embodiments A, B, C include: Element 4 (and optionally Element 7) in combination with one of Elements 1-3; Element 4 in combination with Element 7; Element 5 in combination with Element 7; Elements 4 and 5 in combination with Element 7; Element 5 (and optionally Element 7) in combination with one of Elements 1-3; Elements 4 and 5 (and optionally Element 7) in combination with one of Elements 1-3; Element 6 in combination with one of Elements 1-3; Element 6 in combination with one or more of Elements 8-9; Elements 8 and 9 in combination; one or more of Elements 8-9 in combination with one of Elements 1-3 and optionally one or more of Elements 4-7; one or more of Elements 8-9 in combination with one or more of Elements 4-7; Element 10 in combination with any of the foregoing; and Element 10 in combination with one or more of Elements 1-9.

To facilitate a better understanding of the embodiments described herein, the following examples of preferred or representative embodiments are given. In no way should the following examples be read to limit, or to define, the scope of the disclosure.

### Examples

### Example 1

A plurality of liquid adhesive samples was prepared by compounding cellulose acetate (“CA”) and a plasticizer in the amounts and compositions detailed in Table 1. Sample 1 used a CA having a degree of substitution of about 2.4 and a molecular weight (“Mₙ”) of about 44,000, and Samples 2-10 used a CA having a degree of substitution of about 2.4 and a Mₙ of about 60,000.

The dynamic viscosity of the samples (see Table 1) were measured at 25° C. with a RHEOMETER DISCOVERY HR-2 (rheometer available from TA Instruments) with a cone (1.984° angle) and Peltier plate geometry having a diameter of 40 mm. The shear rate was ramped from 0.01 s⁻¹ to 86641 s⁻¹ with a logarithmic sweep. The dynamic viscosity is reported at a shear rate of 40 s⁻¹.

TABLE 1

| | Cellulose | | Other | Dynamic |
|---|---|---|---|---|
| Sample | Acetate | Plasticizer | Additives | Viscosity |
| 1 | 15 wt % | 85 wt % gamma- | — | 3.9 Pa · s |
| | | valerolactone | | |
| 2 | 10.5 wt % | 30 wt % triacetin | — | 6.8 Pa · s |
| | | 59.5 wt % gamma- | | |
| | | valerolactone | | |
| 3 | 10.5 wt % | 30 wt % diacetin | — | 8.4 Pa · s |
| | | 59.5 wt % gamma- | | |
| | | valerolactone | | |
| 4 | 12.75 wt % | 15 wt % triacetin | — | 13.1 Pa · s |
| | | 72.25 wt % gamma- | | |
| | | valerolactone | | |
| 5 | 10.2 wt % | 40 wt % triacetin | 2.5% glycerin | 8.3 Pa · s |
| | | 47.3 wt % gamma- | | |
| | | valerolactone | | |
| 6 | 10.5 wt % | 30 wt % triacetin | 2.4% glycerin | 7.1 Pa · s |
| | | 57.1 wt % gamma- | | |
| | | valerolactone | | |
| 7 | 7 wt % | 30 wt % triacetin | 3.15% glycerin | 1.5 Pa · s |
| | | 59.9 wt % gamma- | | |
| | | valerolactone | | |
| 8 | 9.1 wt % | 30 wt % triacetin | 2.4% glycerin | 4.2 Pa · s |
| | | 58.5 wt % gamma- | | |
| | | valerolactone | | |
| 9 | 10.2 wt % | 40 wt % triacetin | 2.5% | 9.6 Pa · s |
| | | 47.3 wt % gamma- | polyethylene | |
| | | valerolactone | glycol 300 | |
| 10 | 10.2 wt % | 40 wt % triacetin | — | 8.6 Pa · s |
| | | 49.8 wt % gamma- | | |
| | | valerolactone | | |

This example demonstrates that highly plasticized cellulose esters may be used to produce liquid adhesives. Further, the dynamic viscosity may be tailored independently with cellulose ester concentration, the plasticizer composition, and the composition of other additives. For example, comparing Samples 2 and 3, plasticizing with triacetin appears to produce a less viscous liquid adhesive than diacetin. In another example, comparing Samples 5, 6, and 10, glycerin as a set time modifier appears to have less effect on the dynamic viscosity than polyethylene glycol 300.

Therefore, this disclosure is well adapted to attain the ends and advantages mentioned as well as those that are inherent therein. The particular embodiments disclosed above are illustrative only, as the embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. An adhesive comprising:
a cellulose ester, a starch ester, or both at about 1% to about 30% by weight of the adhesive; and
a plasticizer,
wherein the adhesive has a dynamic viscosity of about 100 Pa·s or less at 25° C. and a shear rate of 40 s⁻¹.

2. The adhesive of claim 1, wherein the plasticizer is at about 20% to about 97% by weight of the adhesive.

3. The adhesive of claim 1, wherein the plasticizer is at about 40% to about 97% by weight of the adhesive.

4. The adhesive of claim 1, wherein the plasticizer is at about 80% to about 97% by weight of the adhesive.

5. The adhesive of claim 1 further comprising a set time modifier at about 0.1% to about 30% by weight of the adhesive.

6. The adhesive of claim 1 further comprising a diluent or a solvent at about 0.1% to about 70% by weight of the adhesive.

7. The adhesive of claim 1, wherein the adhesive consists essentially of the plasticizer and the cellulose ester, the starch ester, or both.

8. The adhesive of claim 1, wherein the adhesive consists essentially of (1) the cellulose ester, the starch ester, or both, (2) the plasticizer, and (3) at least one selected from the group consisting of a diluent, a solvent, a set time modifier, a tackifier, a crosslinker, an insolubilizer, a filler, a water-resistance additive, a flame retardant, a lubricant, a softening agent, an antibacterial agent, an antifungal and/or antimicrobial agent, a preservative, a flow modifier, a pigment, a dye, an antioxidant, a UV-stabilizer, a flowing agent, an aroma, and any combination thereof.

9. The adhesive of claim 1, wherein the cellulose ester, the starch ester, or both have a degree of substitution between about 0.5 and less than about 3.

10. The adhesive of claim 1, wherein the cellulose ester has a molecular weight between about 10,000 and about 300,000.

11. An article comprising the adhesive of claim 1 disposed on a substrate.

12. The article of claim 10, wherein the substrate is a cellulose diacetate film.

13. A method comprising:
applying an adhesive to a first surface moving at a speed of about 1 m/min to about 800 m/min, the adhesive comprising a plasticizer and a cellulose ester, a starch ester, or both with the cellulose ester, the starch ester, or both at about 1% to about 30% by weight of the adhesive, and wherein the adhesive has a dynamic viscosity of about 100 Pa·s or less at 25° C. and a shear rate of 40 s⁻¹, and
adhering a second surface to the first surface with the adhesive.

14. The method of claim 13, wherein the first surface is moving at the speed of about 100 m/min to about 800 m/min.

15. The method of claim 13, wherein the first surface is of a substrate comprising cellulose diacetate.

16. The method of claim 13, wherein the plasticizer is at about 20% to about 97% by weight of the adhesive.

17. The method of claim 13, wherein the plasticizer is at about 40% to about 97% by weight of the adhesive.

18. The method of claim 13, wherein the plasticizer is at about 80% to about 97% by weight of the adhesive.

19. The method of claim 13, wherein the adhesive consists essentially of the plasticizer and the cellulose ester, the starch ester, or both.

20. The method of claim 13, wherein the adhesive consists essentially of (1) the cellulose ester, the starch ester, or both, (2) the plasticizer, and (3) at least one selected from the group consisting of a diluent, a solvent, a set time modifier, a tackifier, a crosslinker, an insolubilizer, a filler, a water-resistance additive, a flame retardant, a lubricant, a softening agent, an antibacterial agent, an antifungal and/or antimicrobial agent, a preservative, a flow modifier, a pigment, a dye, an antioxidant, a UV-stabilizer, a flowing agent, an aroma, and any combination thereof.
